(19) United States
(12) Patent Application Publication
(10) Pub. No.: US 2014/0271261 A1
(43) Pub. Date: Sep. 18, 2014

(54) Automatic Tire Inflator System

(71) Applicant: Bartholomew J. Boelryk, Newmarket (CA)

(72) Inventor: Bartholomew J. Boelryk, Newmarket (CA)

(21) Appl. No.: 14/351,659

(22) PCT Filed: Sep. 14, 2012
(86) PCT No.: PCT/CA2012/000855

§ 371 Date: May 13, 2014

Related U.S. Application Data
(60) Provisional application No. 61/535,099, filed on Sep. 15, 2011.

(51) Int. Cl. B60C 23/12; F04B 35/01

(52) U.S. Cl. CPC B60C 23/12; F04B 35/01
USPC 417/233

(57) ABSTRACT

A tire inflation system is provided for maintaining a predetermined inflation pressure of a tire mounted on a wheel of a vehicle. The system includes a base having a mounting structure for engaging a complementary mounting structure of the wheel, such as lug nuts. A compressor assembly is mounted to the base and rotates about the axis of rotation of the wheel when the vehicle is moving. The compressor assembly includes a reciprocating member such as for instance a piston or a diaphragm that is connected to a crankshaft aligned with the axis of rotation of the wheel. A counterweight is fixedly mounted on one end of the crankshaft, which under the influence of gravity acting on the counterweight results in torque being transferred to the crankshaft to prevent rotation thereof. Resulting relative motion between the compressor and the crankshaft pumps air into the tire via an air conduit.

### CROSS-REFERENCE TO PRIOR APPLICATION

This PCT patent application claims the benefit of U.S. Provisional Patent Application Ser. No. 61/535,099 filed Sep. 15, 2011, entitled “AUTOMATIC TIRE INFLATOR SYSTEM”, the entire disclosure of the application being considered part of the disclosure of this application and hereby incorporated by reference.

### FIELD OF THE INVENTION

The instant invention relates generally to a fluid pressure control apparatus, and more particularly to an automatic tire pressure inflation device that is carried on a vehicle wheel for maintaining a desired inflation pressure within a tire mounted on said wheel.

### BACKGROUND OF THE INVENTION

Maintaining correct inflation pressure in vehicle tires is known to be an effective way to increase fuel economy, decrease tire wear and increase safety. Optimum fuel economy results when vehicle tires are inflated to the proper pressure where the rolling resistance of the tire is minimized. Tire over-inflation causes excessive wear near the middle of the tire's tread due to the tire bulging outward. On the other hand, under-inflation results in excessive wear at the edges of the tire's tread as the tire flattens. It is estimated that improper tire inflation results in billions of dollars of unnecessary tire wear each year in the United States, as well as increasing fuel consumption by about 3% and producing an additional 1400 kilograms of CO₂ emissions per vehicle.

An automobile tire may lose one to two psi of pressure per month in cool weather and more in warmer weather. Additionally, tire pressure varies with the temperature of air in the tire and is consequently affected by vehicle speed, road surface, ambient temperature, etc. Although proper tire inflation may be maintained by regularly checking tire pressure and adjusting accordingly, such maintenance tends to be largely ignored because of the inconvenience that is involved.

A number of systems are known for automatically maintaining tire inflation pressure during the operation of a motorized vehicle. These known systems may be grouped into two broad categories: centralized systems and on-wheel systems. Centralized systems are installed typically on commercial vehicles, such as for instance tractor trailers, and they feed air from a central air tank or compressor to each of the vehicles rotating tires via rotary pneumatic joints and seals. Of course, the use of such rotary seals involves several inherent disadvantages. For instance, installation and maintenance are complex and costly. Further, such rotary joints and seals are necessarily operated in an environment that is inherently hostile to their performance. As such, centralized systems for automatically maintaining tire inflation are not generally considered to be a practical solution for use in automobiles, with the exception of a few high-end luxury brands.

Various on-wheel (or in-wheel) systems are also known. In these systems, a separate inflation mechanism is carried on each wheel of the vehicle such that the pressure of each tire is adjusted using a mechanism that is mounted to the same wheel to which the tire is mounted. Tire deformation-based systems, such as the one disclosed in U.S. Pat. No. 5,975,174 issued to Loewe on Nov. 2, 1999, may include a compressor disposed inside the tire and a plunger for converting deformation of the rotating tire into a linear force for driving a piston of the compressor. Of course, the mechanism is not user-serviceable and is generally inaccessible, requiring the tire to be removed each time maintenance is performed. Alternatively, a wheel-mounted, centrifugally activated air compressor for adjusting tire pressure is disclosed in U.S. Pre-Grant Pat. Pub. No. 2011/0129360 in the name of Clinciu. The system disclosed by Clinciu uses a plurality of pistons and spring-biased centrifugal arms to adjust the pressure of each tire. Not only is the system overly complicated, it is also susceptible to mechanical failure under the harsh operating conditions typically found in the vicinity of vehicle wheels.

It would be advantageous to provide an apparatus that overcomes at least some of the above-mentioned limitations of the prior art.

### SUMMARY OF EMBODIMENTS OF THE INVENTION

According to an aspect of an embodiment of the instant invention, there is provided a tire inflation system for maintaining a predetermined inflation pressure of a tire that is mounted on a wheel of a vehicle, the wheel rotatable about an axis of rotation, the system comprising: a base having a mounting structure for engaging a complementary mounting structure of the wheel of the vehicle; a compressor assembly comprising: a housing fixedly secured to the base and defining an air compression chamber, an air inlet port for taking air into the air compression chamber, and an air outlet port for providing air out of the air compression chamber; a crankshaft having a portion that is aligned along the axis of rotation of the wheel when the base is mounted to the wheel and having a throw that is offset from the axis of rotation, the crankshaft rotatable relative to the base; a reciprocating member coupled to the throw of the crankshaft and defining a portion of an interior surface of the air compression chamber; an air conduit disposed between the air outlet port of the housing and an inflation valve of the tire; and a counterweight fixedly mounted to one end of the crankshaft for supporting relative rotational movement between the crankshaft and the base when the wheel rotates about the axis of rotation.

According to an aspect of an embodiment of the instant invention, there is provided a tire inflation system for maintaining a predetermined inflation pressure of a tire that is mounted on a wheel of a vehicle, the wheel rotatable about an axis of rotation, the system comprising: a base having a mounting structure for engaging a complementary mounting structure of the wheel of the vehicle; a compressor assembly comprising: a housing fixedly secured to the base and defining a cylinder, an air inlet port for taking air into the cylinder, and an air outlet port for providing air out of the cylinder; a crankshaft having a portion that is aligned along the axis of rotation of the wheel when the base is mounted to the wheel and having a throw that is offset from the axis of rotation, the crankshaft rotatable relative to the base; a piston disposed within the cylinder and mechanically coupled to the throw of the crankshaft via a piston rod; an air conduit disposed between the air outlet port of the housing and an inflation valve of the tire; and a counterweight fixedly mounted to one end of the crankshaft for supporting relative rotational movement between the crankshaft and the base when the wheel rotates about the axis of rotation.

According to an aspect of an embodiment of the instant invention, there is provided a tire inflation system for maintaining a predetermined inflation pressure of a tire that is mounted on a wheel of a vehicle, the wheel rotatable about an axis of rotation, the system comprising: a base having a mounting structure for engaging a complementary mounting structure of the wheel of the vehicle; a rotary reciprocating compressor comprising: a crankshaft having a first end rotatably coupled to the base, the crankshaft having a portion that is aligned along the axis of rotation when the base is mounted to the wheel of the vehicle and having a throw that is offset from the axis of rotation; a counterweight fixedly secured to a second end of the crankshaft, the second end opposite the first end, the counterweight supporting relative rotational movement between the crankshaft and the base; a reciprocating member carried by the base and coupled to the throw of the crankshaft such that, when the wheel rotates about the axis of rotation, the reciprocating member orbits around the crankshaft to produce linear motion of the reciprocating member alternating in an intake-stroke direction and in an outlet-stroke direction; and an air conduit for providing fluid communication between the rotary reciprocating compressor and an inflation valve of the tire.

### BRIEF DESCRIPTION OF THE DRAWINGS

Exemplary embodiments of the invention will now be described in conjunction with the following drawings, in which:

FIG. 1 is an exploded view of an on-wheel automatic tire inflator system, according to an embodiment of the instant invention.

FIG. 2 is a perspective view showing the system of FIG. 1 mounted to a wheel.

FIG. 3 is a front view showing the system of FIG. 1 mounted to a wheel.

FIG. 4 is a cross-sectional view taken along the line D-D in FIG. 3.

FIG. 5 shows enlarged detail of the structure within the circle in FIG. 4.

FIG. 6 shows piston displacement at several different points during rotation about the axis of rotation R-R.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Referring to FIG. 1, shown is an exploded view of an on-wheel automatic tire inflator system according to an embodiment of the instant invention. The automatic tire inflator system, which is shown generally at 2, is secured to wheel 4 via a base 6. For instance, the base 6 is formed using known injection molding techniques. The base 6 has a mounting structure (not shown) formed along one side thereof for engaging a complementary mounting structure of the wheel 4. In particular, the mounting structure of base 6 engages lug nut structures 8 of the wheel 4. As such, the automatic tire inflator system is readily retrofitted on existing vehicles, without requiring any special modifications to the wheel 4 or to the vehicle more generally.

A rotary reciprocating compressor 10 is fixedly mounted to base 6, such that the compressor 10 rotates with the wheel 4 as the wheel 4 rotates about rotational axis R-R. The compressor 10 includes a not illustrated crankshaft that is coupled to a not illustrated piston via a not illustrated piston rod. One end of the not illustrated crankshaft is rotatably coupled to the base 6. A counterweight 12 is fixedly secured to the other end of the not illustrated crankshaft. An air conduit 14 extends between the compressor 10 and an inflator valve 16 of a tire 18 mounted on the wheel 4. An auxiliary inflator valve 20 is provided for supporting auxiliary inflation of the tire 18, such as by using an electrically powered air compressor at a service center, as well as measuring of the internal pressure of the tire 18. A cover 22 is provided, which in an assembled condition is secured to the base 6 so as to contain the components of the tire inflator system. As is well known, the wheel area of a vehicle is a particularly hostile environment due to the presence of airborne contaminants such as for instance brake dust. Accordingly, the cover 22 is baffled to help protect the compressor 10 from contamination. For instance, the cover 22 is formed using known injection molding techniques and has labyrinth passageways through which the air must flow before reaching the compressor 10. Optionally, replaceable air filters are contained in the cover 22 for filtering the air before it is drawn into the compressor 10. The low volume of air that is required to maintain predetermined inflation pressure of the tire 18 results in extended service life of the air filters.

FIG. 2 is a perspective view showing the tire inflator system 2 of FIG. 1 in an assembled condition and mounted to the wheel 4. As is shown in FIG. 2, the cover 22 provides a low profile and completely contains the other components of the tire inflator system. The air conduit 14 emerges through a side portion of the cover and is mechanically coupled to inflator valve 16 of the tire 18. For instance, the end of the air conduit 14 includes a threaded connector that is screwed onto a threaded stem of the inflator valve 16.

FIG. 3 is a front view of the tire inflator system 2 of FIG. 1 in an assembled condition and mounted to the wheel 4. As is shown clearly in FIG. 3, the cover 22 hides all of the other components of the tire inflator system and lug nuts 8, giving an aesthetically appealing finish when the system 2 is mounted to the wheel 4.

Referring now to FIG. 4, shown is a cross-sectional view taken along the line D-D in FIG. 3. FIG. 4 shows more clearly the low profile that the cover 22 presents, wherein most of the components of the automatic tire inflation system 2 are disposed within the space between lug nuts 8 of the wheel 4. This efficient use of space in the wheel region not only hides the existence of the automatic tire inflation system 2, but also offers protection if the wheel is driven inadvertently into a curb or a post, etc.

FIG. 5 shows enlarged detail of the structure that is contained within the circle in FIG. 4, including the structure of the rotary reciprocating compressor 10. The base 6 includes features, such as for instance shaped recess 50, which engage lug nuts 8 for securing the base 6 to the wheel 4. The components of the reciprocating compressor 10 are substantially nested within the space between the lug nuts 8. Reciprocating compressor 10 comprises a housing 52 that is fixedly secured to the base 6. The housing 52 defines a cylinder 54, an air inlet port 56 and an air outlet port 58. A piston 60 is disposed within the cylinder 54 and is mechanically coupled to crankshaft 62 via a piston rod 64. Counterweight 12 is shown fixedly mounted to an end of the crankshaft 62. In the specific and non-limiting example that is shown in FIG. 5, a bleed valve 66 is provided for bleeding off excess pressure from the tire 18. Also shown in FIG. 5 is a portion 14a of the air conduit 14, which extends between the air outlet port 58 and the auxiliary inflator valve 20. The portion 14a of the air conduit 14 is contained within the space between the cover 22 and the base 6.

The compressor 10 is controlled using, for instance, two one-way check valves, which are optionally ball-style or flapper-style in design. One check valve is disposed at the air inlet port 56 and one check valve is disposed at the air outlet port 58. When air is taken in through the check valve at air inlet port 56 during an intake stroke, the check valve at the air outlet port 58 is closed so as to prevent air leakage from the tire 18. Similarly, when air is forced out through the check valve at air outlet port 58 during an outlet stroke, the check valve at the air inlet port 56 is closed so as to prevent air leakage out of the cylinder 54 to the external surroundings.

Operation of the automatic tire inflator system 2 is described with reference to FIGS. 1-5. It is to be understood that each wheel of a vehicle is equipped with an automatic tire inflator system 2 that is substantially identical to the one described hereinabove. When the vehicle is in motion, wheel 4 rotates about rotation axis R-R. Since the base 6 is mounted to lug nuts 8 of wheel 4, the base 6 rotates about rotation axis R-R at the same rate as does the wheel 4. The housing 52 is mounted to the base 6, and therefore the housing 52, the piston 60 and the piston rod 64 all rotate about the rotation axis R-R. A portion of the crankshaft 62 is aligned along the rotation axis R-R, but due to the connection to piston 60 via piston rod 64 the crankshaft 62 normally has a tendency to rotate. In the environment of the wheel 4 it is not possible to couple either of the ends of crankshaft 62 to a structure that does not rotate about the rotation axis R-R. Accordingly, in order to prevent rotation of the crankshaft 62 when the wheel 4 rotates about rotation axis R-R, the counterweight 12 is secured to one end of the crankshaft 62. Gravity acts on counterweight 12 resulting in torque being applied to the one end of crankshaft 62. The applied torque opposes the tendency of the crankshaft 62 to rotate about the rotation axis R-R when the vehicle is in motion. By preventing rotation of the crankshaft 62, the counterweight 12 supports relative rotational motion between the crankshaft 62 and the base 6. From the point of view of the crankshaft 62, the compressor 10 orbits around the axis of rotation R-R.

Referring also FIG. 6, the crankshaft 62 includes a portion that is aligned along the axis of rotation R-R, as well as a throw 68 that is offset from the axis of rotation R-R. The piston rod 64 is coupled to the throw 68 of crankshaft 62. Since the counterweight 12 (not shown in FIG. 6) prevents rotation of the crankshaft 62 about the axis of rotation R-R, the throw 68 remains substantially stationary. Since the housing 52 is fixedly mounted to the base 6, the distance between the cylinder 54 and the axis of rotation R-R remains constant as the base 6 rotates with the wheel 4. The distance between the throw 68 and the piston 60 also remains constant as the base 6 rotates with the wheel 4, and as a result the piston 60 moves relative to the cylinder 54. The amount by which the throw 68 is offset from the axis of rotation R-R determines the stroke of the piston 60 within the cylinder 54 of the compressor 10. In the simplified diagram that is shown in FIG. 6, the throw 68 is directly above the axis of rotation R-R, such that the top of an outlet stroke occurs when the cylinder 54 is directly above the axis of rotation R-R. As the cylinder 54 rotates clockwise in FIG. 6, the piston 60 is drawn through an intake stroke. The bottom of the intake stroke occurs when the cylinder 54 is directly below the axis of rotation R-R, where the distance between the throw 68 and the cylinder 54 is greatest. As the cylinder 54 continues to rotate clockwise in FIG. 6, the air that was drawn into the cylinder 54 during the intake stroke is forced out during another outlet stroke.

The size of the compressor components and of the counterweight varies depending upon the particular application. Based on an optimal tire inflation pressure of 240 kilopascal (35 psi) and a 7.5 centimeter counterweight lever arm, a counterweight weighing 45 grams may be used, which is equivalent to less than about 16.5 cubic centimeters of steel or a similar material. This weight is based on a piston diameter of 7.8 mm and a stroke of 7 mm, which results in a displacement of 0.3 cubic centimeters. A tire size of P215/60R16 yields 480 revolutions per kilometer, resulting in about 165 cubic centimeters per kilometer of driving or almost 8200 cubic centimeters after driving fifty kilometers.

The automatic tire inflator system 2 further includes a mechanism for limiting pressure in the interior of tire 18, such that over inflation does not occur. In the specific and non-limiting example that is shown in FIGS. 1-5, a bleed off valve 66 is provided to allow over pressure to bleed off. Such a mechanism is accurate and reliable, but requires continuous operation of the compressor 10, resulting in small inefficiency. Additionally, a not illustrated check valve is incorporated into the system 2 when the bleed off valve 66 is used for controlling pressure, so as to prevent air leakage from the tire 18 back through the compressor 10.

An alternative mechanism for limiting pressure in the tire 18 involves sizing the counterweight 12 appropriately such that once the desired operating pressure is achieved the system pressure causes the counterweight 12 to circle with the wheel 4 and base 6. Depending on the mass of the circling counterweight 12, the wheel 4 may become unbalanced. However, if the radius of circling of the counterweight 12 is sufficiently small this unbalance may not be problematic.

Another alternative mechanism for limiting pressure in the tire 18 involves incorporating a mechanism into the automatic tire inflator system 2 for decoupling the crankshaft 62 of the compressor 10 using the centrifugal force of the spinning counterweight 62. Reengaging the drive when the inflation pressure of tire 18 falls below the predetermined pressure is achieved, for instance, using a diaphragm device with an actuator rod.

It should be noted that FIGS. 5 and 6 depict a reciprocating mechanism in the form of piston 60 that moves within cylinder 54. Alternatively, another type of reciprocating mechanism is used. For instance, the compressor 10 described with reference to FIGS. 1-6 optionally is replaced with a compressor having a diaphragm disposed adjacent to and forming one side of the internal surface of a compression chamber. The diaphragm is coupled to crankshaft 62, and is caused to bulge into the compression chamber during an outlet stroke and to bulge out of compression chamber during an intake stroke. Such a design is simple and does not require maintenance of seals between a piston and the wall of a cylinder.

Optionally, the automatic tire inflator system 2 includes an indicator device, such as for instance a spring biased diaphragm device with an actuator and a visible indicator, for providing visual confirmation that the system is operating correctly. When the system is not operating correctly, optionally maintenance is performed or the entire system is replaced.

The automatic tire inflator system 2 is used to maintain a desired or predetermined pressure within the tire 18 of wheel 4. The desired or predetermined pressure is the optimum inflation pressure of the tire 18. Typically, a recommended inflation value is provided on the sidewall of tire 18. The desired or predetermined pressure is either the inflation pressure value provided on the sidewall of tire 18, or a different pressure that is considered to be optimum under particular operating conditions. For instance, the desired or predetermined value may be higher than or lower than the inflation pressure value that is provided on the sidewall of tire 18 depending on factors such as the ambient temperature, the type of road surface, the amount of cargo being carried, the style of driving anticipated, etc. Optionally, the desired or predetermined pressure is a range of pressure values centered approximately on the optimum inflation pressure of the tire 18.

Numerous other embodiments may be envisaged without departing from the scope of the instant invention.

1. A tire inflation system for maintaining a predetermined inflation pressure of a tire that is mounted on a wheel of a vehicle, the wheel rotatable about an axis of rotation, the system comprising:
a base having a mounting structure for engaging a complementary mounting structure of the wheel of the vehicle;
a compressor assembly comprising:
a housing fixedly secured to the base and defining an air compression chamber, an air inlet port for taking air into the air compression chamber, and an air outlet port for providing air out of the air compression chamber;
a crankshaft having a portion that is aligned along the axis of rotation of the wheel when the base is mounted to the wheel and having a throw that is offset from the axis of rotation, the crankshaft rotatable relative to the base;
a reciprocating member coupled to the throw of the crankshaft and defining a portion of an interior surface of the air compression chamber;
an air conduit disposed between the air outlet port of the housing and an inflation valve of the tire; and
a counterweight fixedly mounted to one end of the crankshaft for supporting relative rotational movement between the crankshaft and the base when the wheel rotates about the axis of rotation.

2. The tire inflation system according to claim 1, wherein during use the relative rotational movement between the crankshaft and the base is converted to linear movement of the reciprocating member alternating in an intake-stroke direction for taking air into the compression chamber and in an outlet-stroke direction for providing air out of the compression chamber and into the inflation valve of the tire via the air conduit.

3. The tire inflation system according to claim 1, wherein the reciprocating member is a piston.

4. The tire inflation system according to claim 1, wherein the reciprocating member is a diaphragm.

5. The tire inflation system according to claim 1, wherein the mounting structure of the base engages facing lug nut structures of the wheel.

6. The tire inflation system according to claim 1, comprising a cover including labyrinth passageways and an air filter system for filtering air prior to the air being taken into the compression chamber via the air inlet port.

7. The tire inflation system according to claim 1, comprising an auxiliary valve for supporting auxiliary inflation of the tire bypassing the compressor assembly.

8. The tire inflation system according to claim 1, comprising an adjustable bleed-off valve for bleeding off pressure of the interior of the tire exceeding the predetermined inflation pressure.

9. The tire inflation system according to claim 1, wherein the counterweight is sized to support operation of the compressor assembly when the inflation pressure of the tire is less than approximately the predetermined inflation pressure and to disengage operation of the compressor assembly when the inflation pressure of the tire is greater than approximately the predetermined inflation pressure.

10. A tire inflation system for maintaining a predetermined inflation pressure of a tire that is mounted on a wheel of a vehicle, the wheel rotatable about an axis of rotation, the system comprising:
a base having a mounting structure for engaging a complementary mounting structure of the wheel of the vehicle;
a compressor assembly comprising:
a housing fixedly secured to the base and defining a cylinder, an air inlet port for taking air into the cylinder, and an air outlet port for providing air out of the cylinder;
a crankshaft having a portion that is aligned along the axis of rotation of the wheel when the base is mounted to the wheel and having a throw that is offset from the axis of rotation, the crankshaft rotatable relative to the base;
a piston disposed within the cylinder and mechanically coupled to the throw of the crankshaft via a piston rod;
an air conduit disposed between the air outlet port of the housing and an inflation valve of the tire; and
a counterweight fixedly mounted to one end of the crankshaft for supporting relative rotational movement between the crankshaft and the base when the wheel rotates about the axis of rotation.

11. The tire inflation system according to claim 10, wherein during use the relative rotational movement between the crankshaft and the base is converted to linear movement of the piston alternating in an intake-stroke direction for taking air into the cylinder and in an outlet-stroke direction for providing air out of the cylinder and into the inflation valve of the tire via the air conduit.

12. The tire inflation system according to claim 10, wherein the mounting structure of the base engages facing lug nut structures of the wheel.

13. The tire inflation system according to claim 10, comprising a cover including labyrinth passageways and an air filter system for filtering air prior to the air being taken into the compression chamber via the air inlet port.

14. The tire inflation system according to claim 10, comprising an auxiliary valve for supporting auxiliary inflation of the tire bypassing the compressor assembly.

15. The tire inflation system according to claim 10, comprising an adjustable bleed-off valve for bleeding off pressure of the interior of the tire exceeding the predetermined inflation pressure.

16. The tire inflation system according to claim 10, wherein the counterweight is sized to support operation of the compressor assembly when the inflation pressure of the tire is less than approximately the predetermined inflation pressure and to disengage operation of the compressor assembly when the inflation pressure of the tire is greater than approximately the predetermined inflation pressure.

17. A tire inflation system for maintaining a predetermined inflation pressure of a tire that is mounted on a wheel of a vehicle, the wheel rotatable about an axis of rotation, the system comprising:
a base having a mounting structure for engaging a complementary mounting structure of the wheel of the vehicle;
a rotary reciprocating compressor comprising:
a crankshaft having a first end rotatably coupled to the base, the crankshaft having a portion that is aligned along the axis of rotation when the base is mounted to the wheel of the vehicle and having a throw that is offset from the axis of rotation;
a counterweight fixedly secured to a second end of the crankshaft, the second end opposite the first end, the counterweight supporting relative rotational movement between the crankshaft and the base;
a reciprocating member carried by the base and coupled to the throw of the crankshaft such that, when the wheel rotates about the axis of rotation, the reciprocating member orbits around the crankshaft to produce linear motion of the reciprocating member alternating in an intake-stroke direction and in an outlet-stroke direction; and
an air conduit for providing fluid communication between the rotary reciprocating compressor and an inflation valve of the tire.

18. The tire inflation system according to claim 17, wherein the reciprocating member is a piston.

19. The tire inflation system according to claim 17, wherein the reciprocating member is a diaphragm.

20. The tire inflation system according to claim 17, wherein the mounting structure of the base engages facing lug nut structures of the wheel.

21. The tire inflation system according to claim 17, comprising a cover including labyrinth passageways and an air filter system for filtering air prior to the air being taken into the compression chamber via the air inlet port.

22. The tire inflation system according to claim 17, comprising an auxiliary valve for supporting auxiliary inflation of the tire bypassing the compressor assembly.

23. The tire inflation system according to claim 17, comprising an adjustable bleed-off valve for bleeding off pressure of the interior of the tire exceeding the predetermined inflation pressure.
